(19) United States
(12) Patent Application Publication
(10) Pub. No.: US 2026/0168933 A1
(43) Pub. Date: Jun. 18, 2026

(54) ACTIVATABLE HUMIDITY AND GAS SENSORS

(71) Applicant: Zebra Technologies Corporation, Lincolnshire, IL (US)

(72) Inventors: Eric W. LIBERATO, Pequannock, NJ (US); Marielle K. SMITH, Parlin, NJ (US); Mohannad ABDO, Clifton, NJ (US); Brian S. HUFFMAN, Belle Mead, NJ (US)

(73) Assignee: Zebra Technologies Corporation, Lincolnshire, IL (US)

(21) Appl. No.: 19/416,633

(22) Filed: Dec. 11, 2025

Related U.S. Application Data
(60) Provisional application No. 63/735,527, filed on Dec. 18, 2024.

(51) Int. Cl. G01N 21/78

(52) U.S. Cl. CPC G01N 21/78

(57) ABSTRACT

Humidity- or gas-exposure indicators include a substrate having a plurality of humidity or gas-impermeable microcapsules on or in the substrate, the microcapsules comprising a humidity-or gas-sensitive payload, the microcapsules preventing exposure of the payload to humidity or gas while intact, the payload producing an observable effect indicating the presence of humidity or gas when exposed to humidity or gas above a predetermined threshold after the microcapsules have been exposed to an activating stimulus which ruptures, fractures, dissolves, or renders permeable the microcapsules.

### CROSS-REFERENCE TO RELATED APPLICATIONS

The present disclosure claims the benefit of U.S. Provisional Patent Application No.: 63/735,527 entitled “ACTIVATABLE HUMIDITY AND GAS SENSORS” and filed on Dec. 18, 2024, which is incorporated herein by reference in its entirety

### BACKGROUND

Many commercial products are sensitive to overly high or low humidity or the presence of certain gases (e.g., oxygen, ammonia, ethylene, etc.). Exposure to such high or low humidity or gas concentrations, and/or extended periods of time at elevated humidity or gas levels may cause a product to spoil or lose efficacy/quality. The presence of certain toxic gases may even pose a threat to life and property. The conditions of the commercial products can be monitored by detecting the presence of certain gases. In the areas of gardening and farming, determining soil moisture content is useful for optimizing plant growth.

There is a continued need for improved environmental humidity-or gas-exposure indicator to detect such exposure.

### SUMMARY

The indicators of the present disclosure comprise encapsulated payloads that are released when the indicator is subjected to an activating stimulus.

In some embodiments, provided herein is a humidity-or gas-exposure indicator, comprising:
a substrate;
a plurality of humidity or gas-impermeable microcapsules on or in the substrate, the microcapsules comprising a humidity-or gas-sensitive payload, the microcapsules preventing exposure of the payload to humidity or gas while intact, the payload producing an observable effect indicating the presence of humidity or gas when exposed to humidity or gas above a predetermined threshold after the microcapsules have been exposed to an activating stimulus which ruptures, fractures, dissolves, or renders permeable the microcapsules.

In some embodiments, an activating stimulus is pressure (e.g., pressures ranging from about 5 psi to about 20 psi, e.g., pressure applied by pinching between fingers and thumb). In some embodiments, an activating stimulus is temperature (e.g., temperature ranging from about 25 ° C. to about 250° C.).

In some embodiments, the observable effect is a change in a color state of the indicator, wherein the change in color state comprises a change of at least one property selected from hue, chroma, transparency, opacity, or combinations thereof.

In some embodiments, the payload is a hydrochromic ink.

In some embodiments, the hydrochromic ink is selected from a mixture of a triphenylmethane dye, an oxidizing agent, a base and a humectant; a mixture of an inorganic weak acid, a triarylmethane dye, and a hygroscopic agent; a mixture of copper bromide, a dye and a bromide salt; a silica gel impregnated iron (III) salt; a sugar gel containing ionic dyes; a composite of porphyrin, magnesium dichloride and silica gel; an inorganic polymer containing an acid-base indicator; hydroxyethyl cellulose containing methylene blue and urea; a composite of polyvinyl alcohol and sodium borate decahydrate; lithium hydroxide; calcium hydroxide; potassium hydroxide; sodium hydrogen carbonate; magnesium hydroxide; sodium thiosulfate pentahydrate; sodium hydroxide; cobalt nitrate; copper (II) sulfate; copper nitrate; iron (III) sulfate; iron (II) sulfate; iron (II) Chloride; iron (III) chloride; Cobalt (II) Chloride; or magnesium chloride; or any combination thereof.

In some embodiments, the microcapsules are transparent or translucent while intact.

In some embodiments, the indicator further comprises an indicator area, wherein after the activation stimulus is applied to the microcapsules, and responsive to the payload being exposed to a predetermined level of humidity or gas, at least a portion of the payload migrates to the indicator area, the presence of the payload in the indicator area producing the observable effect.

In some embodiments, the indicator further comprises an electrical circuit, and wherein the payload, when released from the microcapsules and exposed to gas or humidity produces a change of electrical property in a component of the electrical circuit.

In some embodiments, the change of electrical property of the component comprises a change in capacitance, and the electrical circuit is configured to detect a capacitance value.

In some embodiments, the indicator is a humidity indicator, the payload includes a hygroscopic carrier, and exposure to humidity above a predetermined level causes the hygroscopic carrier to liquify, the liquified hygroscopic carrier flowing to the indicator area.

In some embodiments, the indicator further comprises an electrical circuit, and flowing of the liquified hygroscopic carrier to the indicator area produces a change of electrical property in a component of the electrical circuit.

In some embodiments, the payload further includes a color former or a developer, the color former or color developer migrates to the indicator area after the hygroscopic carrier liquifies and reacts with a color developer or a color former in the indicator area producing the observable effect.

In some embodiments, where the payload includes a hygroscopic carrier, the payload further includes a material selected from the group consisting of PVA, PVP, PEG, acrylics, water reducible epoxy, cellulose, water soluble gum, PEG, titanium dioxide nanoparticles, barium titanate nanoparticles, silicon dioxide nanoparticles, carbon black, graphene, metallic nanoparticles, PVDF, polystyrene, polyethylene, ionic liquids, lead zirconate titanate, aluminum oxide, zinc oxide, magnesium oxide, iron oxide, manganese dioxide, copper oxide, nickel oxide, strontium titanate, zirconium dioxide, calcium copper titanate, boron nitride, cadmium sulfide, lead magnesium niobate, lanthanum nickelate, hafnium oxide, yttrium oxide, indium tin oxide, gallium nitride, tantalum pentoxide, bismuth ferrite, polytetrafluoroethylene, polyimide, polycarbonate, epoxy resin, polyethylene terephthalate, polyvinyl chloride, polypropylene, silicones, conductive polyaniline, conductive polypyrrole, or combinations thereof.

In some embodiments, the hygroscopic carrier that liquifies in the presence of humidity is a polymer, a metal salt, or a metal oxide.

Also provided is a process for preparing the indicators described herein, the process comprising:
providing a substrate;
providing a humidity-or gas-sensitive payload; providing a permeable material for forming a shell surrounding, and in contact with, the payload;
providing a sealing material; and
co-extruding the payload, the permeable material, and the sealing material to provide microcapsules having a humidity-or gas-sensitive payload core surrounded by a humidity-or gas-impermeable shell when intact and which, after exposure to an activating stimulus, ruptures, fractures, dissolves, or renders permeable the microcapsules; and
overlaying the substrate with the microcapsules.

In some embodiments, overlaying the substate with microcapsules comprises coating the substrate with a mixture of the microcapsules in a carrier (e.g., a solvent), then drying the coated substrate. In some embodiments, overlaying the substate with microcapsules comprises soaking the substrate in a mixture comprising the microcapsules and a carrier (e.g., a solvent) to provide a substrate coated and/or impregnated with the microcapsules.

Provided is a humidity-or gas-exposure indicator, prepared according to the process described above.

In some embodiments, provided is a microcapsule comprising
a humidity- or gas-sensitive payload core;
a humidity- or gas-impermeable shell surrounding the payload core and including a permeable material for forming a shell surrounding, and in contact with, the payload, and a sealing material;
   where the shell, after exposure to an activating stimulus, ruptures, fractures, dissolves, or renders permeable the microcapsule.

In some embodiments, the sealing material seals pores in the permeable material.

In some embodiments, the permeable material is selected from polyethylene, polypropylene, polyethylene terephthalate, polyvinyl chloride, polystyrene, ethylene vinyl alcohol, nylon, polycarbonate, acrylates, thermoplastic polyurethane, fats, waxes, fatty acids, alcohols, side chain crystalline (SCC) polymers, sugars (lactose, sucrose, trehalose), shellac, polyethylene glycols, polyvinyl (alcohol, pyrrolidone, acetate), polylactide, polylactide-co-glycolide, polyacrylic acids, polyacrylates, resins (hydrocarbon, terpenes), latex, metals, ethylene-vinyl acetate polymer, fatty alcohols, mono-glycerides, di-glycerides, triglycerides, polyanhydrides, polylactic acid, or sugar derivatives (dextrins).

In some embodiments, the sealing material is selected from polydimethylsiloxane, polymethylsilsesquioxane, silicone polymers, gelatin, protein, polyurea formaldehyde, polymelamine formaldehyde, wax material, melamine, cellulose derivatives (e.g., Ethocel®, Methocel®, HPMCP), polysaccharides (alginate, pectin, pullulan, carrageenans), starches, maltodextrins, proteins (gelatin, zein, casein, caseinate, whey proteins, soy proteins, albumin), chitosan, gums (arabic, xanthan, gellan, guar, pectins), clay/kaolin, or poly(1,1,2,2-tetrafluorethylene). In some embodiments, the clay may be a kaolin. In some embodiments, the clay/kaoplon may be one or more of Montmorillonite, Kaolinite, Bentonite, Illite, Halloysite, Laponite, Sepiolite, or Palygorskite (Attapulgite).

In some embodiments, a material such as a wax may be either a permeable material or a sealing material. For example, when permeable, the wax may have a lower melting point compared to when the wax is acting as a sealing material. When acting as a sealing material the wax may have a melting point well above the temperature used for activation of the indicators described herein.

In some embodiments, the payload in the microcapsule comprises about 5% to about 90% by weight of the microcapsule, and the permeable material and the sealing material together comprise about 10% to about 95% by weight of the microcapsule.

In some embodiments, the shell comprises about 80% to about 95% of the permeable material and about 5% to about 20% of the sealing material by weight of the total material used in the shell.

In some embodiments, the permeable material is an SCC polymer and the sealing material is a clay/kaolin. In some embodiments, the shell is a single shell comprising a mixture of an SCC polymer and a clay/kaolin. In some embodiments, the shell is a dual shell comprising an inner shell of SCC polymer and an outer shell of clay/kaolin. In some embodiments, the SCC material may have a melt temperature ranging from about 40° C. to about 120° C.

Further provided is a process for preparing a microcapsule comprising:
providing a humidity-or gas-sensitive payload;
providing a permeable material for forming a shell surrounding, and in contact with, the payload;
providing a sealing material; and
co-extruding the payload, the permeable material, and the sealing material to provide a microcapsule having a humidity-or gas-sensitive payload core surrounded by a humidity-or gas-impermeable shell when intact, and which, after exposure to an activating stimulus, ruptures, fractures, dissolves, or renders permeable the microcapsules.

In some embodiments, the microcapsule is a single shell microcapsule prepared by mixing the permeable material and the sealing material prior to the co-extrusion. In such embodiments, the co-extrusion is a co-extrusion of two immiscible fluids using two concentric nozzles for a co-axial co-extrusion, as described in the detailed description section.

In some embodiments, the co-extruding is conducted in an extruder having concentric nozzles.

In some embodiments, the sealing material seals pores in the permeable material.

In some embodiments, the microcapsule is a dual shell microcapsule prepared by overlaying a continuous layer of the sealing material on the shell formed by the permeable material. In such embodiments, the co-extrusion is a co-extrusion of three immiscible fluids using three concentric nozzles for a co-axial co-extrusion, as described in the detailed description section.

Further provided is a microcapsule prepared by the processes described herein (e.g., by co-axial co-extrusion, or by a spinning disc method).

### BRIEF DESCRIPTION OF THE DRAWINGS

The accompanying figures, where like reference numerals refer to identical or operationally similar elements throughout the separate views, together with the detailed description below, are incorporated in and form part of the specification, and serve to further illustrate embodiments of concepts that include the claimed invention, and explain various principles and advantages of those embodiments.

FIG. 1A depicts a first embodiment of a microcapsule, according to embodiments of the present disclosure.

FIG. 1B depicts a second embodiment of a microcapsule, according to embodiments of the present disclosure.

FIGS. 2A-2B depict an embodiment of a humidity-exposure color changing indicator according to embodiments of the present disclosure.

FIGS. 3A-3B depict an embodiment of an insertable humidity-exposure color changing indicator, according to embodiments of the present disclosure.

FIGS. 4A-4B depict an embodiment of a humidity-exposure color changing indicator having distinct activation and indicator areas, according to embodiments of the present disclosure.

FIGS. 5A-5D depict an embodiment of an activatable RFID enabled humidity or gas exposure indicator and features thereof, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Humidity or gas-sensing indicators render an observable change, e.g., a change in color state or an electrical property, when a threshold level of humidity or gas is detected. For example, when goods are shipped, or when goods are unpacked, it is desirable to determine the humidity or gas in the shipping container at the time of sealing or opening the shipping container, and also to determine whether the goods have been exposed to an undesirable level of gas or humidity during shipment. A disadvantage with some existing indicators is that, prior to the association of the indicator with a host product to be monitored, the indicator must be shielded from the humidity or gas which the indicator is configured to detect. As an example, the conditions of commercial products such as fruit need to be monitored for the presence of certain gases, such as ethylene. In such situations, indicators that can be activated by a user are desirable.

Some environmental exposure indicators may be irreversible, that is exposure to a particular condition, e.g. a certain level of humidity or gas exposure, causes an observable state change in the indicator that remains after the exposure ends, possibly indefinitely. This allows prior exposure to a condition that affects product quality, e.g., in the supply chain or in storage, to be detected. However, prior to use of the indicators, e.g., prior to pairing the indicator to a host product, the indicator itself may be spoiled, or its effective life reduced, by exposure to the condition it is intended to monitor. An indicator which indicates cumulative environmental exposure, providing some indication of remaining product life or product freshness, if it is prematurely exposed to the environmental condition, may underestimate the remaining product life or freshness, thereby causing product that is actually acceptable to be discarded. A solution to this is to provide an indicator that does not respond to the sensed environmental condition prior to an activation event.

The indicators provided herein are activatable indicators, so that even if they are exposed to the predetermined environmental condition that they are intended to monitor, they do not provide an observable change until after an activating stimulus has been provided. An activating stimulus may be a temperature change (e.g., applying heat with a heat lamp or thermal printer), or a pressure (e.g., a user may press an activation area or the indicator may be passed through a nip, e.g., formed by a roller and a thermal printhead). The indicators provided herein comprise payloads encapsulated in impermeable shells to form microcapsules. The microcapsules are configured to rupture, fracture, dissolve, or are otherwise rendered permeable when subjected to an activating stimulus, releasing the payloads contained therein. When the payloads are released, the payloads are exposed to the environment and can begin environmental sensing. Once environmental sensing (e.g., responsive to activation) has begun, the payloads (e.g., alone or in tandem with other features of the indicator) produce an observable change/readout when exposed to a humidity or gas above an indication threshold, the observable change indicating the presence the humidity or gas. In this manner, the time at which the indicator becomes environmentally sensitive is selectable by a user.

As used herein, “payload” refers to the material that is contained in the microcapsules, then when released from the microcapsule and exposed to a predetermined environmental condition, causes an observable state change, such as a change in an indicator color state, or such as a change in electrical property. The payload may be a single material that changes in response to the condition and causes the observable change, or a first material that changes responsive to the environmental change, e.g., by liquifying or flowing, that then releases or transports another material that causes the observable change. The payload may cause the change in situ, or when released and exposed to the environmental condition, travel to another location where the observable indication is provided. In some embodiments, a payload is a colorant/ink (e.g., a color former, a color developer, hydrochromic ink), or a material that can change an electrical property of an electrical component, or a hygroscopic carrier, or any combination thereof. Examples of payloads are provided in the description below.

“Activating stimulus,” “activation,” or “activation action” refers to an action that causes an indicator to respond to a subsequent environmental stimulus (e.g., the action primes the indicator for environmental sensing). Prior to activation, the payload is contained in the gas or humidity impermeable shell, and is blocked from producing the observable effect (e.g., either alone or in tandem with other features of an indicator) responsive to the microcapsule being exposed to the condition which the payload is configured to respond to. The activation may cause microcapsules to release a payload from the shell, or to otherwise allow humidity or gas to pass through the shell to interact with the payload. For example, the activating stimulus is an applied pressure or temperature exposure above an activation threshold applied to the microcapsules which ruptures, breaks, melts, or dissolves the shells, disengages the shells from the payloads, releases the payload from the shell, or renders a shell porous.

In some embodiments, an activating stimulus is a compressive or shearing stress of about 5 psi to about 20psi, which may be enacted on the microcapsules by the application of external pressures, such as a compressive force.

In some embodiments, an activating stimulus is a thermal exposure above an activation threshold. In some embodiments, the activation threshold of the activating stimulus is a temperature of about 45° C. to about 250° C. In some embodiments, the activation threshold of the activating stimulus is a temperature of about 185° C. to about 250° C. In some embodiments, the activation threshold of the activating stimulus is a temperature of about 45° C. to about 100° C.

In some embodiments, a “color developer” is a material, e.g., an acid, a base, an oxidant, or a reducing agent, capable of initiating the color of a dye by reaction with the dye precursor. In such an embodiment, the dye is a “color former”. In other embodiments, the color developer is humidity, and the color former is a hydrochromic ink or a metal salt that changes color or becomes colored in the presence of humidity.

As used herein, a “humidity-or gas-impermeable shell” is a shell surrounding a payload and together with the payload forms a microcapsule. In some embodiments, the shell is a single shell comprising a mixture of a permeable material and a sealing material and encloses the payload. In some embodiments, the shell is a dual shell having an inner shell comprising a permeable material which surrounds and is in contact with a payload, and the inner shell is overlaid with a sealing material to form the outer shell of the dual shell. A shell is substantially impermeable to humidity or gas when intact and protects the payload from contact with humidity or a gas. An impermeable shell is suitably friable and/or frangible and/or has burst characteristics. After the microcapsules have been exposed to an activating stimulus, such as heating or pressure, the shell ruptures, fractures, dissolves, or becomes permeable/porous, exposing the payload for contact with humidity or a gas. As used herein, “microcapsules rupturing, fracturing, dissolving, or becoming permeable/porous” means that the microcapsules'shell or shells ruptures, fractures, dissolves, or becomes permeable/porous.

As used herein, “permeable material” refers to a material which has pores, gaps or melted areas that allow ingress of humidity or gas.

As used herein, “sealing material” is dense and/or waxy and/or a continuous phase material that is impermeable to humidity or gas.

As used herein, “overlaying” a substrate with microcapsules refers to coating the substrate, or impregnating (e.g., by soaking) the substrate with a mixture of microcapsules.

As used herein, “indicator area” refers to a portion of a device where an observable change indicating exposure to a predetermined environmental stimulus is produced. The indicator area may overlap with the location of microcapsules described herein or may not (e.g., the microcapsules may be in a reservoir which is in a location that is different from the location where the observable change occurs or is detected).

As used herein, “color state” includes chroma, hue, darkness, transparency or opacity. A color state change is a change in one of these properties, which may be visible to a human eye, or may also occur in manner that is optically machine readable, in some cases in wavelengths not visible to the human eye.

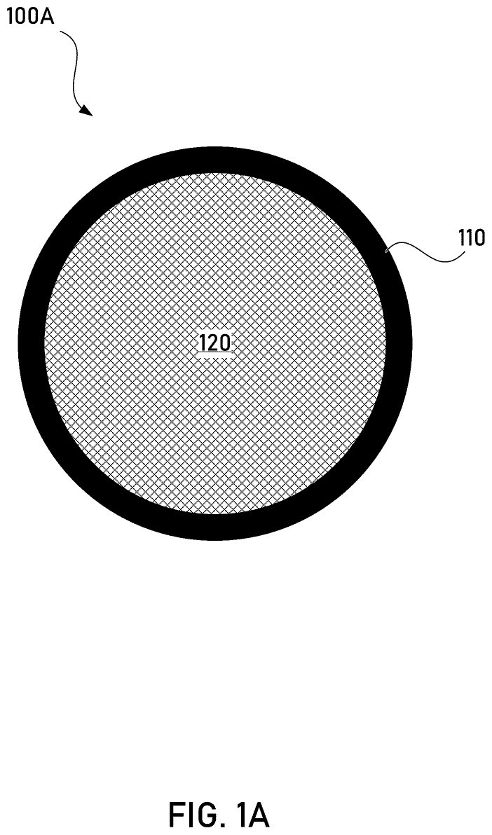

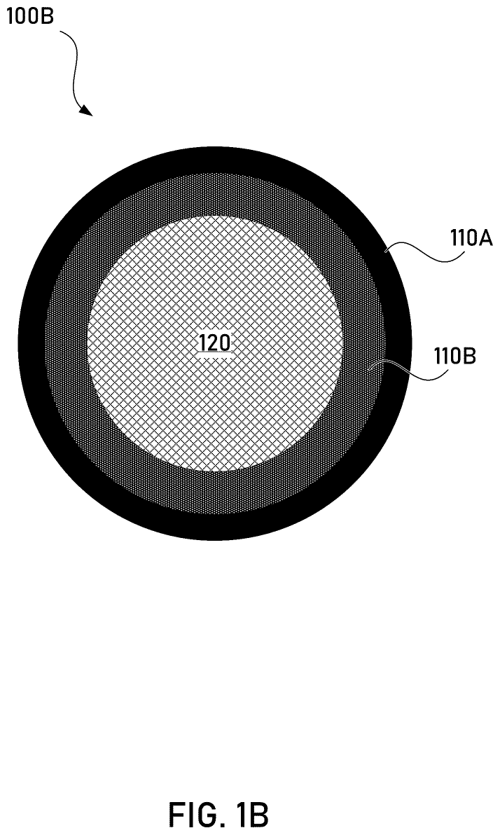

FIG. 1A shows a cross section of a first embodiment of a microcapsule 100A. An impermeable shell 110 surrounds, and is in contact with, a payload 120. The impermeable shell 110 is a single shell prepared by mixing a permeable material and a sealing material and forming a single shell around the payload 120.

FIG. 1B shows a cross section of a second embodiment of a microcapsule 100B. The impermeable shell 110 around the payload 120 comprises an outer shell 110A and an inner shell 110B. The inner shell 110B comprises permeable material and surrounds, and is in contact with, the payload 120. The outer shell 110A comprises a sealing material forming a continuous phase around the inner shell 110B. The first embodiment of the microcapsule 100A and the second embodiment of the microcapsule 100B may be generally or collectively referred to as microcapsule(s) 100.

In some examples, the payload 120 of the microcapsules 100 may be a hydrochromic ink, surrounded by a gas/water impermeable shell 110. Prior to activation, the payload 120 does not respond to humidity (water vapor) or liquid water, because the impermeable shell 110 blocks humidity or liquid water from contact with the payload. After activation, the shell 110 ruptures, breaks, melts, dissolves, or becomes porous, and the payload 120 is released from the microcapsule 100, or in the case of a microcapsule becoming porous, it is possible that instead of releasing the payload, the relevant gas or humidity is instead allowed to enter and interact with the payload still contained in the microcapsule. Release from the microcapsule 100 exposes the payload 120 rendering it sensitive to environmental stimuli. The released payload 120 (e.g., hydrochromic ink), after exposure to humidity above a threshold, undergoes an observable change, i.e., a color change in response to contact with humidity or liquid water.

In other examples, the payload 120 is a dielectric material surrounded by a gas/humidity impermeable shell 120. Prior to activation, the payload 120 does not respond to humidity (water vapor), gas (e.g., ammonia) or liquid water, because the impermeable shell 110 blocks humidity, gas, or liquid water from contacting the payload 120. After activation, the shell 110 ruptures, breaks, melts, dissolves, or becomes porous, and the payload 120 is released from the microcapsule 100. Release from the microcapsule 100 exposes the payload 120 rendering it sensitive to environmental stimuli. The released payload 120 (e.g., dielectric material), after exposure to humidity, gas or liquid water above a threshold, causes a change in capacitance, as explained below, which can be detectable as an observable change.

In a third embodiment, the payload 120 is a hygroscopic carrier surrounded by a gas/humidity impermeable shell. Prior to activation, the payload 120 does not respond to humidity (water vapor), gas (e.g., ammonia) or liquid water, because the impermeable shell 110 blocks humidity, gas, or liquid water from contacting the payload. After activation, the shell 110 ruptures, breaks, melts, dissolves, or becomes porous. Release from the microcapsule exposes the payload 120 rendering it sensitive to an environmental stimulus. The released hygroscopic carrier, after exposure to humidity, gas or liquid water, liquifies or melts and flows to an indicator area causing a change in color or capacitance which is detectable as an observable change. For example, a hygroscopic carrier may be a hygroscopic polymer such as polyvinyl pyrrolidinone, or hydrophilic urethanes (e.g., HydroMed™ D4). In addition to a hygroscopic carrier, the payload may also include a color former or a color developer. When the liquified payload flows to an indicator area, it reacts with a color developer or a color former causing an observable color change. In some embodiments, when the liquified payload flows to an indicator area, it causes a change in capacitance, as explained below, which can be detected as an observable change.

In some examples, the hydrochromic ink enclosed in the microcapsules 100 is a mixture of a triphenylmethane dye, an oxidizing agent, a base and a humectant, or a mixture of an inorganic weak acid, a triarylmethane dye, and a hygroscopic agent. In other examples the hydrochromic ink enclosed in the microcapsules 100 is a mixture of copper bromide, a dye and a bromide salt. In yet other examples, the hydrochromic ink enclosed in the microcapsules 100 is a silica gel impregnated with an iron (III) salt, a sugar gel containing ionic dyes, or a composite of porphyrin, magnesium dichloride and silica gel. In some examples, the hydrochromic ink enclosed in the microcapsules 100 is an inorganic polymer containing an acid-base indicator, hydroxyethyl cellulose containing methylene blue and urea, or a composite of polyvinyl alcohol and sodium borate decahydrate. In some examples the hydrochromic ink enclosed in the microcapsules 100 may be any suitable compound exhibiting a color change responsive to contact with liquid water.

According to another embodiment, the microcapsules 100 include a compound capable of forming hydrates where the hydrates have a different color from the non-hydrated form of the compound. The compound may be chosen and/or configured to form a certain amount of the hydrated compound respondent to a certain level of relative humidity (RH), thus as a predetermined % RH is reached in the environment, the compound may form an amount of hydrate sufficient to incur a color change visible to the naked eye. In some embodiments, the microcapsules comprise one or more of cobalt nitrate; copper (II) sulfate; copper nitrate; iron (III) sulfate; iron (II) sulfate; iron (II) Chloride; iron (III) chloride; or Cobalt (II) Chloride which can change color after hydrates are formed.

In further embodiments, the microcapsules 100 include a color former or a color developer, and a hygroscopic carrier, i.e., a compound that can liquify when it comes in contact with humidity. When the microcapsules are subjected to an activated stimulus and release the payload, the liquified hygroscopic carrier flows and carries a color developer or a color former to the indicator area to initiate a reaction with a color former or a color developer thereby causing a color change. In such embodiments, the indicator area may be coated or impregnated with a color former or a color developer. In such embodiments, the color developer may be, for example, an acid, a base, an oxidant, or a reducing agent, capable of initiating the color change of a dye by reaction with the dye precursor. In this embodiment, the dye is a color former. In some embodiments, the color developer may be one or more of lithium hydroxide; calcium hydroxide; potassium hydroxide; sodium hydrogen carbonate; magnesium hydroxide; sodium thiosulfate pentahydrate; magnesium chloride; or sodium hydroxide, that can cause a color change in a dye or a metal salt, so that the dye or metal salt is a color former.

Alternatively, the color developer may be, for example, an oxidant, or a reducing agent, capable of changing the oxidation state of a metal salt and cause a color change. In this embodiment, the metal salt is a color former.

In embodiments where a hygroscopic carrier is included in a payload, the indicator may include a reservoir of microcapsules in proximity to the indicator area so that the released payload can flow to the indicator area.

The hygroscopic carrier may be any material that can liquify in the presence of humidity such as a polymer, a metal salt, or a metal oxide. The metal salt or metal oxide may form hydrates that may be flowable or spread/expand (e.g., aluminum hydroxide forming a gel, or a desiccant like sodium chloride absorbing water). In some embodiments, the hygroscopic carrier may include at least one of hydrophilic or hygroscopic materials. In some embodiments, the hygroscopic carrier may include at least one of PVA, PVP, PEG, acrylics (e.g., neutralized polyacrylate), water-reducible epoxy, cellulose or cellulosic polymers, water-soluble gums, PEG, or any combination thereof.

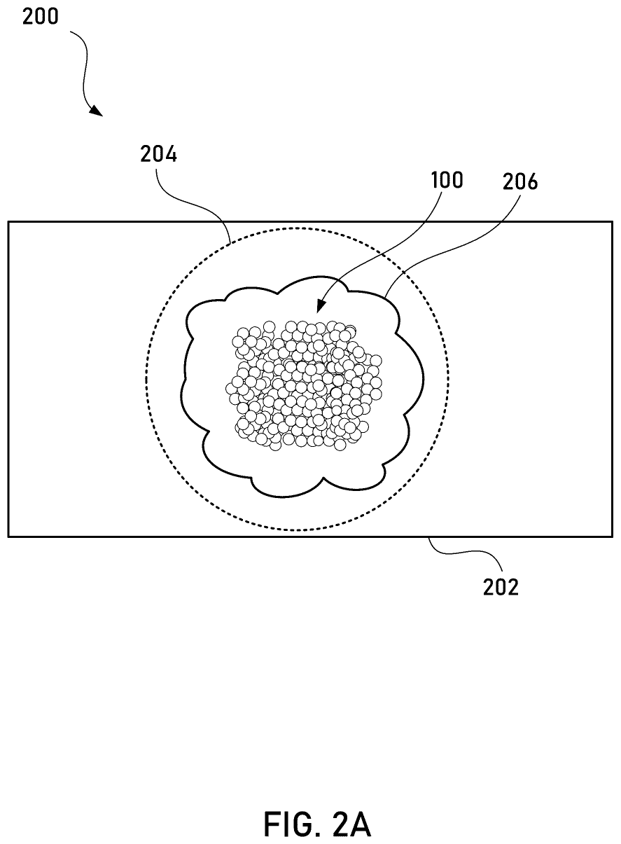

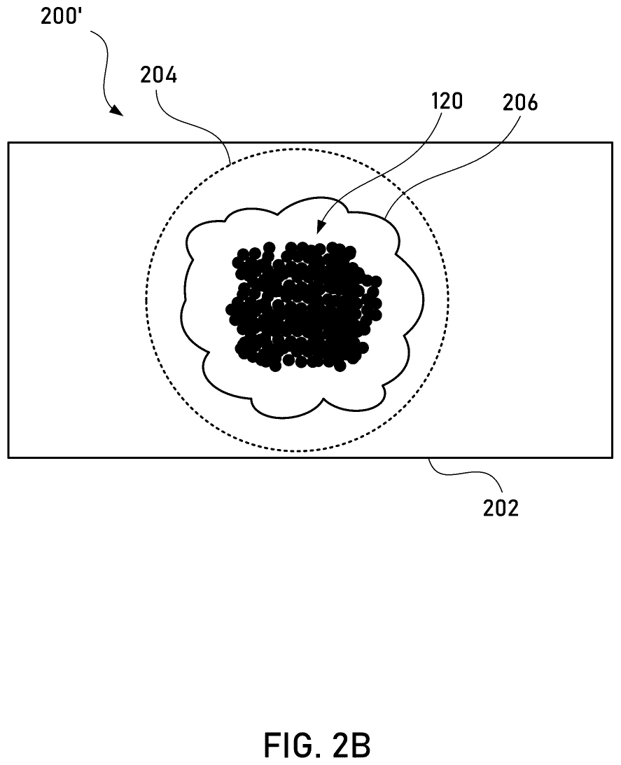

FIG. 2A shows an activatable color change humidity indicator 200 in an initial unactivated state, according to embodiments of the present disclosure. An indicator area 204 is defined on, or operatively coupled to a substrate 202. The indicator area 204 is coated or impregnated with microcapsules 100. An optional carrier material/solvent/adhesive 206 may be used to commute or adhere microcapsules 100 to the indicator area 204. In various examples, the activatable color change humidity indicator 200 employs the first embodiment of the microcapsules 100A, or the second embodiment of the microcapsules 100B. Prior to activation, and when intact, the microcapsules 100 provide the indicator area 204 with an initial appearance, (e.g., a first color state). The initial appearance of the indicator area 204 (e.g., of the microcapsules therein) may be transparent or translucent. In some embodiments, the indicator area 204 may include a wick or other absorbent material to draw or collect humidity or water vapor to the payload 120. When the indicator is subjected to an activating stimulus (e.g., squeezing with fingers, exposure to a roller, a heat lamp or a thermal printer) the microcapsules 100 are ruptured, fractured, melted, dissolved, or otherwise rendered porous or permeable to humidity. The activating stimulus is preferably directed towards the indicator region 204 and the microcapsules 100, such that the microcapsules are ruptured by the activating stimulus.

FIG. 2B shows the activatable color change humidity indicator 200′ at a period in time after activation and a subsequent exposure to humidity above a predetermined threshold, according to embodiments of the present disclosure. After the application of the activating stimulus, which ruptures, fractures, melts, dissolves, or otherwise renders the microcapsule shell porous, the payload 120 is released from the microcapsules 100, thus activating the indicator. After the payload is released, an exposure to humidity at or above the predetermined humidity threshold will cause the observable effect to be produced in the indicator area 204. The observable effect may be a color state change in the appearance of the microcapsules. After activation, and responsive to the humidity exposure, the indicator area 204 (e.g., the exposed payload 120) may exhibit a secondary appearance (e.g., second color state). The second appearance of the indicator area 204 may be darkened, opaque or a color which contrasts with the substrate 202, or the first appearance.

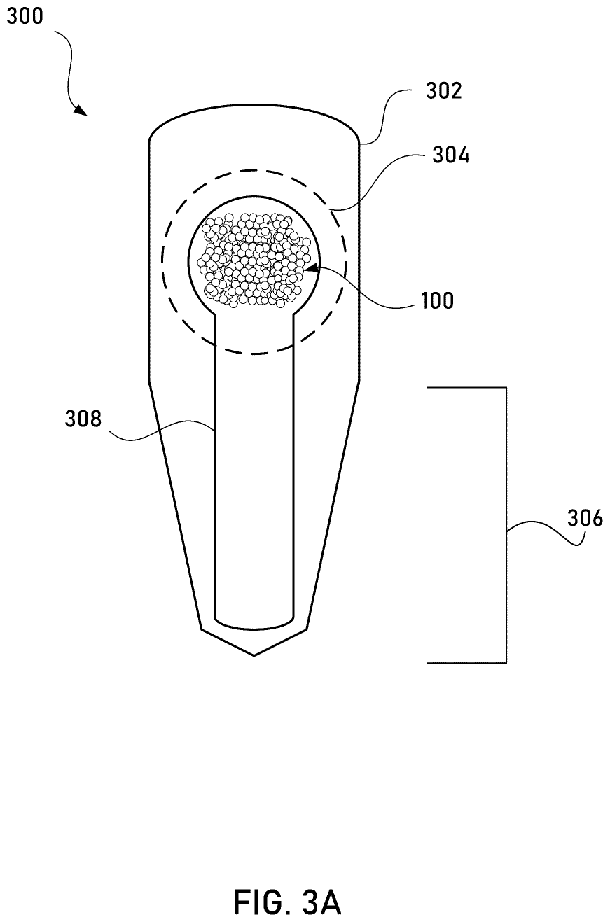

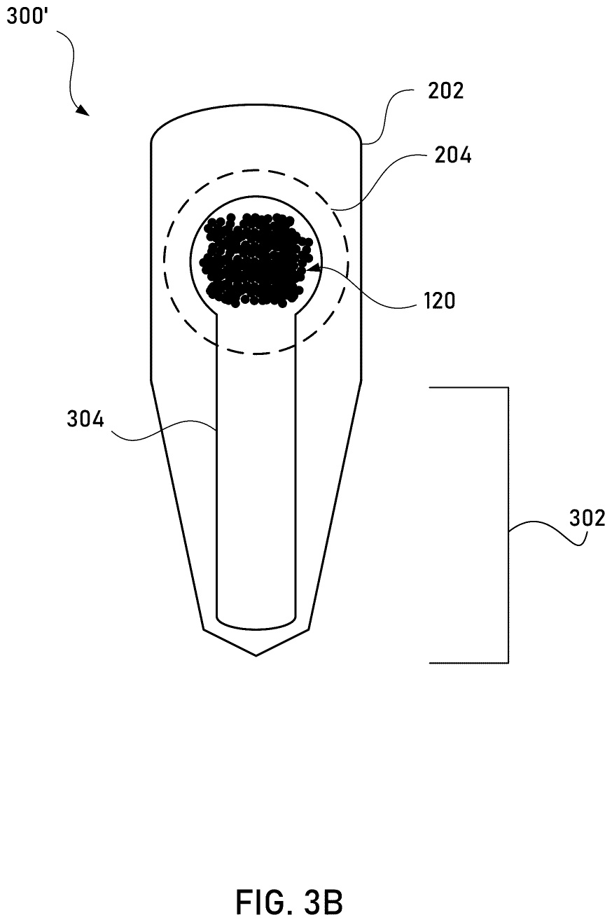

FIG. 3A shows an activatable color change humidity indicator 300 in an initial unactivated state, according to embodiments of the present disclosure. The indicator 300 includes a substrate 302 which defines an insertable end 306, such that the indicator 300 is insertable into an analyte (e.g., soil sample, granular media). A portion of the substrate 302, preferably opposite to the insertable portion 302, is coated or impregnated with microcapsules 100. An absorbent material 308 is disposed longitudinally along the insertable portion and is in contact with the indicator area 304 (and preferably the microcapsules 100). The absorbent material 308 is configured to draw moisture from the analyte up to the indicator area 304. Prior to activation, and when intact, the microcapsules 100 provide the indicator area 203 with an initial appearance, (e.g., a first color state). The initial appearance of the indicator area 304 (e.g., of the microcapsules therein) may be transparent or translucent. In some embodiments, the indicator area 304 may include a wick or other absorbent material to draw or collect humidity or water vapor to the payload 120. When the indicator is subjected to an activating stimulus (e.g., squeezing with fingers, exposure to a roller, a heat lamp or a thermal printer) the microcapsules 100 are ruptured, fractured, melted, dissolved, or otherwise rendered porous or permeable to humidity. The activating stimulus is preferably directed towards the indicator region 304 and the microcapsules 100, such that the microcapsules are ruptured by the activating stimulus.

FIG. 3B shows an activatable color change humidity indicator 300′ at a period in time after activation and a subsequent exposure to humidity above a predetermined threshold, according to embodiments of the present disclosure. After the application of the activating stimulus, which ruptures, fractures, melts, dissolves, or otherwise renders the microcapsule shell porous, the payload 120 is released from the microcapsules 100, thus activating the indicator. After the payload is released, an exposure to humidity at or above the predetermined humidity threshold will cause the observable effect to be produced in the indicator area 304. The observable effect may be a color state change in the appearance of the microcapsules. After activation, and responsive to the humidity exposure, the indicator area 304 (e.g., the exposed payload 120) may exhibit secondary appearance (e.g., second color state). The second appearance of the indicator area 304 may be darkened, opaque or a color which contrasts with the substrate 302, or the first appearance.

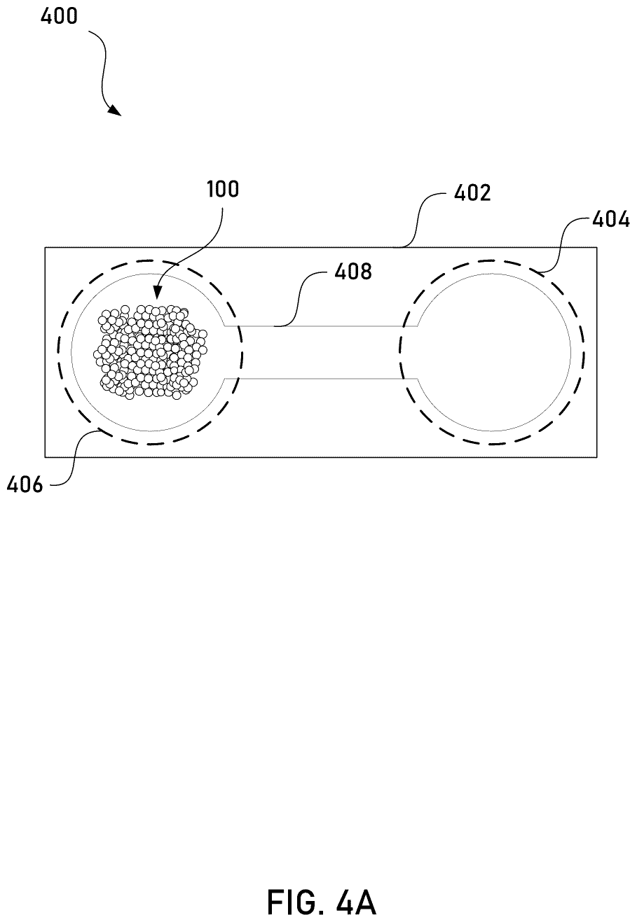

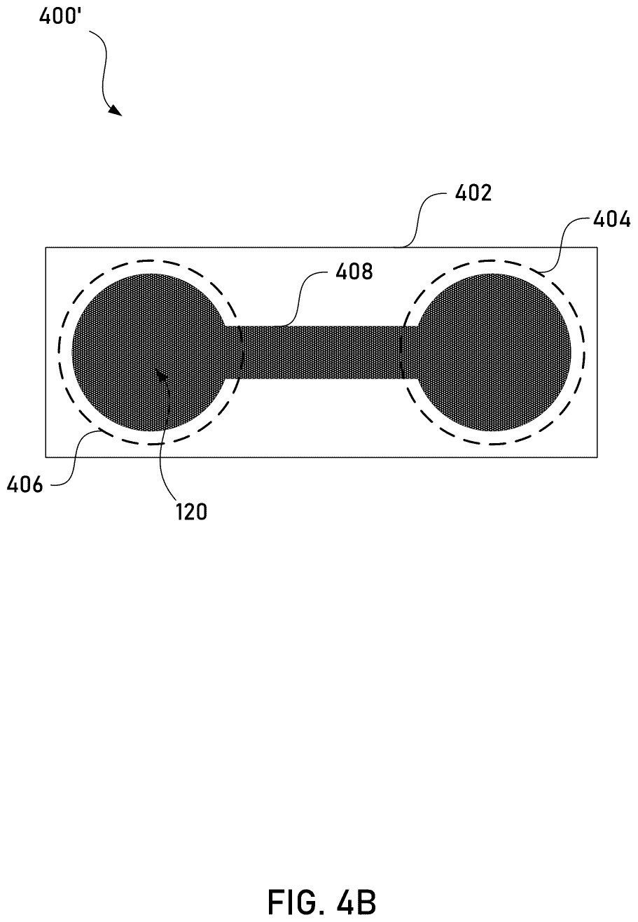

FIG. 4A shows an activatable color change humidity indicator 400 in an initial state, prior to activation, according to embodiments of the present disclosure. In in some examples of the indicator 400, the payload 120 of the microcapsules 100 is a hygroscopic carrier and further includes one of a color former and color developer. The microcapsules 100 are disposed in an activation area 406, which is defined on, or operatively coupled to a substrate 402. The activation area 406 is in fluid communication with an indicator area 404 via a fluid connector 408. In various examples, the fluid connector 408 may be a wick, or a plurality of microchannels or capillary tubes. The indicator area 404 may be coated or impregnated with a color developer or color former, complementary to the color former or color developer contained in the payload 120 within the microcapsules 100. When an activating stimulus such as pressure is applied to the activation area 406, the microcapsules 100 are ruptured, and the payload 120 (e.g., hygroscopic carrier and one of a color former and color developer) is released, thus rendering the indicator 400 sensitive to an environmental stimulus.

FIG. 4B illustrates the activatable color change humidity indicator 400′, at a point in time after activation and exposure to humidity above the predetermined threshold. After the activating stimulus is applied to the activation area 406, and responsive to an exposure to humidity above a predetermined threshold, the hygroscopic carrier liquifies and flows through the fluid connector 408 into the indicator area 404. The indicator area 404 may be an absorbent material into which the liquified hygroscopic carrier can percolate. The liquified hygroscopic carrier transports a color former for a color developer included in it to the indicator area. The indicator area 404 may be coated or impregnated with a color developer or color former, complementary to the color former or color developer contained in the payload 120, such that a color change (e.g., observable effect) is produced in the indicator area 404. Optionally, the indicator may include a cover layer such that the microcapsules in the activation area 406, and the fluid connector 408 may be concealed. The cover layer may be made of a permeable material to allow ingress of humidity or gas.

In some embodiments, a color changing humidity indicator 200, 300, or 400 may include a plurality of indicator areas 204, 304, 404 each containing a different color changing component, such that each indicator area is tuned to indicate progressively higher levels of relative humidity.

In some embodiments, the color change in the indicator 200, 300, or 400 is irreversible. That is, after the microcapsules 100 are subjected to an activating stimulus and the payload 120 is released, then exposed to humidity above a threshold, a color change is observed, and the indicator area does not return to its initial color or initial colorless state. In such examples, the hydrochromic ink or hydrochromic compound may be undergoing a one-way or irreversible change in response to the presence of humidity.

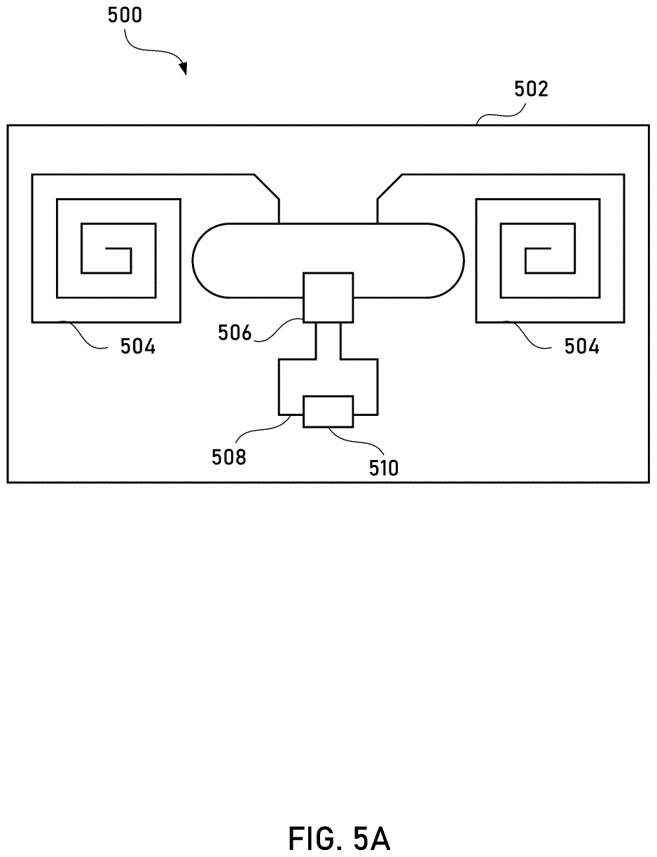

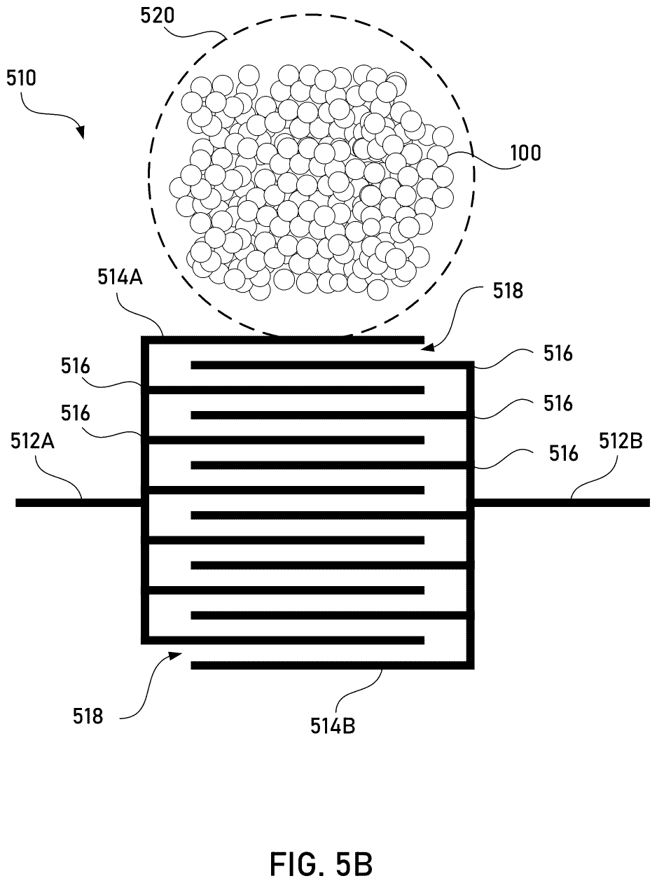

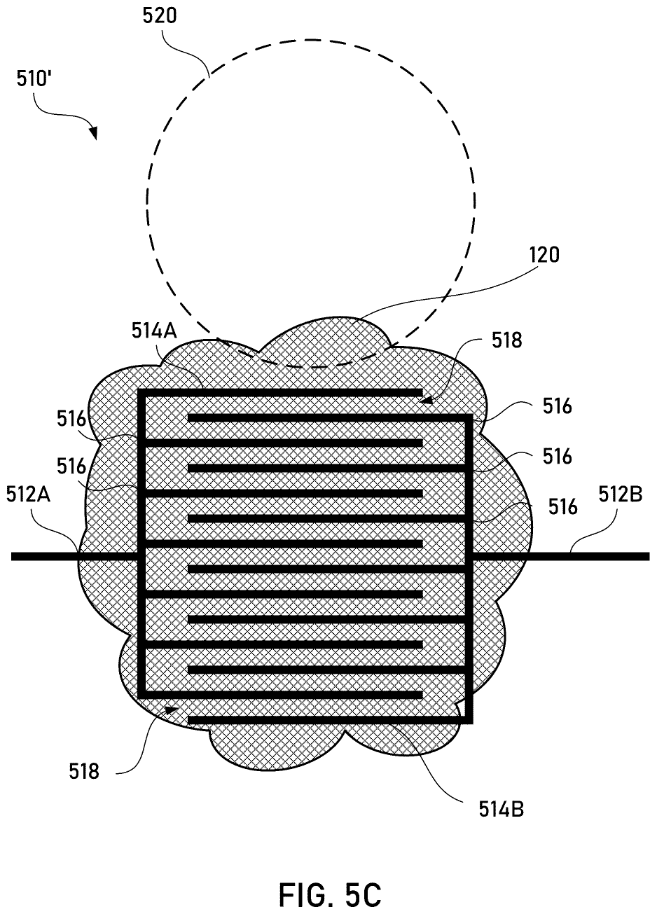

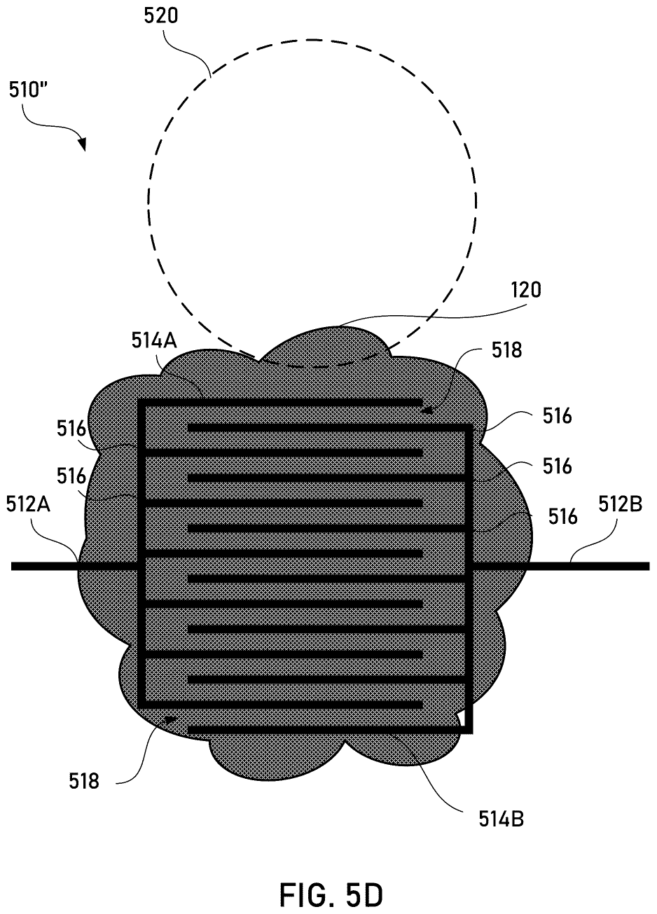

FIG. 5A depicts an activatable RFID/NFC enabled humidity or gas indicator 500 (e.g., indicator 500), according to embodiments of the present disclosure. The indicator 500 includes an RFID/NFC tag coupled to a substrate 502, the tag including an integrated circuit 506 (e.g., microchip) connected to one or more antennas 504 and an electrical circuit 508. The electrical circuit 506 includes an activatable humidity or gas detector 510 which is depicted in detail and discussed in FIGS. 5B-5C. The integrated circuit 506 causes the antenna(s) 504 to emit a radiofrequency (RF) response signal responsive to the indicator 500 being interrogated by an RF interrogation signal at a predetermined frequency and power range, where the interrogation signal is received by the antenna(s) 504. The integrated circuit 506 is configured to, and responsive to receiving the interrogation signal via the antenna(s) 504, and read or query the electrical circuit 508. The activatable humidity or gas detector 510 is configured to change an electrical property of the electrical circuit 508, which is recognized by the integrated circuit 506 when the integrated circuit 506 queries or reads the electrical circuit 508. The integrated circuit 506 is configured to change the response signal based on the electrical property of the electrical circuit 508 which is affected by the activatable humidity or gas detector 510.

FIG. 5B illustrates the activatable humidity or gas detector 510 as may be employed in the RFID/NFC enabled humidity or gas indicator 500, according to embodiments of the present disclosure. The activatable humidity or gas detector 510 includes a first wire/trace 512A electrically connected to a first electrode 514A, which is opposed to a second electrode 514B, which is in turn electrically connected to a second wire/trace 212B. The first electrode 514A and the second electrode 514B (generally or collectively electrodes 514), are separated from one another by a gap 518. In some examples, the electrodes 514 include prongs 516. The prongs 516 of the first electrode 514A are interleaved with the prongs 516 of the second electrode 514B, such that the gap 518 is maintained between the electrodes 514, and the first electrode 514A and the second electrode 514B do not touch one another. The first wire/trace 512A and the second wire/trace 512B (generally or collectively wires 512) are respectively connected to the integrated circuit 506, completing the electrical circuit 508.

A plurality of microcapsules 100 are disposed proximately to the electrodes 514 and may be disposed in a demarcated activation area 520, configured to receive the activating stimulus. The payload 120 of the microcapsules 100 includes a liquified dielectric material. Prior to activation of the microcapsules 100, the gap 518 between the electrodes is unfilled, or is filled with air. As a result, the activatable humidity or gas detector 510 (e.g. and therefore the electrical circuit 508) has a first capacitance prior to activation of the microcapsules.

FIG. 5C depicts the activatable humidity or gas detector 510′ after the activating stimulus has been applied to the microcapsules 100, according to embodiments of the present disclosure. After the activating action is applied to the microcapsules 100, the released payload 120 flows into the gap 518 between the electrodes 514. The dielectric constant of the gap 518 is changed as a result of the presence of the payload 120, which in turn changes the capacitance of the activatable humidity detector 510. Thus, the activatable humidity or gas detector 510′ (e.g. and therefore the electrical circuit 508) has a second capacitance after activation.

In some examples, the flow of the payload 120 may be directed into the gap 518 by a fluid connector (e.g., see the fluid connector 408 of FIG. 4), such as a wick, microchannels or capillary tubes.

FIG. 5D. illustrates the activatable humidity detector 510″ after activation, and after an exposure to humidity or gas above a predetermined threshold occurring subsequently to activation. When the payload 120 is released from the microcapsules 100, the dielectric material contained therein is configured to change the dielectric constant gap 518 responsive to an exposure to humidity or gas above a predetermined threshold. When such an exposure occurs, the resulting change in the dielectric constant of the gap 518 changes the capacitance of the activatable humidity or gas detector 510″. Therefore, after the activatable humidity or gas detector 510′ is activated and subsequently exposed to humidity or gas above the predetermined threshold, the activatable humidity or gas detector 510′ (e.g. and therefore the electrical circuit 508) has a third capacitance. The change in capacitance from the first capacitance to the third capacitance is detectable as an observable change.

In some embodiments, when the dielectric material / payload 120 fills only a portion of the gaps 508, the remaining space in the gaps 508 may be filled with other filler material or component, including air, silicon dioxide, or any other suitable non-conductive material. In some embodiments, the filler material or component may be stable (e.g., tend not to change its dielectric constant) in response to a change in humidity, gas, or temperature. In some embodiments, the change in electrical property resulting from the dielectric material/payload 120 filling gaps 508 may be at least one or several orders of magnitude higher than any change in electrical property of the filler material or component in the remaining space of the gap 508.

Generally, the integrated circuit 506 is configured to measure or detect the capacitance of the electrical circuit 508 and change the response signal of the activatable RFID/NFC enabled humidity or gas indicator 500. In some examples, the response signal may have a first distinct frequency when the electrical circuit has the first capacitance, a second distinct frequency when the electrical circuit has the second capacitance and have a third distinct frequency when the electrical circuit has the third capacitance. In some examples, the integrated circuit 5006 may be configured to emit no response when the electrical circuit has a particular capacitance of the first capacitance, the second capacitance, and the third capacitance. In some examples, the integrated circuit may be configured to include one or more data in the response signal when the electrical circuit has a particular capacitance of the first capacitance, the second capacitance, and the third capacitance.

The activatable humidity or gas detector 510 may be configured to change a capacitance value thereof in response to both the change in humidity or a change in gas concentration. For example, a single humidity or gas indicating RFID/NFC microchip may be configured to detect both the change in humidity and the change in gas concentration at the same time. In other examples, the humidity or gas indicating RFID/NFC microchip may be configured to change a capacitance value thereof in response to only one of the change in humidity and the change in gas concentration.

In some embodiments, the dielectric material which is payload 120 in FIG. 5A or FIG. 5B may include a material including at least one of polyol polymers, neutralized polymers, or any combinations thereof. In particular, in some examples, the dielectric material may include at least one of hydrophilic and hygroscopic materials. For example, the dielectric material may include a material including at least one of PVA, PVP, PEG, acrylics (e.g., neutralized polyacrylate), water-reducible epoxy, cellulose, water-soluble gum, PEG, hydrochromic ink, or any combinations thereof.

In other embodiments, the dielectric material may be made with any other suitable non-conductive material that changes its dielectric constant in response to exposure to the environmental stimulus, e.g., humidity or concentration of a particular gas. In some embodiments, the above-discussed dielectric materials may further include other additional materials, such as potassium hydroxide (KOH) and/or isopropyl alcohol (IPA). In some embodiments, the dielectric material may be PVA, PVP, PEG, acrylics, water reducible epoxy, cellulose, water soluble gum, PEG, titanium dioxide nanoparticles, barium titanate nanoparticles, silicon dioxide nanoparticles, carbon black, graphene, metallic nanoparticles, PVDF, polystyrene, polyethylene, ionic liquids, lead zirconate titanate, aluminum oxide, zinc oxide, magnesium oxide, iron oxide, manganese dioxide, copper oxide, nickel oxide, strontium titanate, zirconium dioxide, calcium copper titanate, boron nitride, cadmium sulfide, lead magnesium niobate, lanthanum nickelate, hafnium oxide, yttrium oxide, indium tin oxide, gallium nitride, tantalum pentoxide, bismuth ferrite, polytetrafluoroethylene, polyimide, polycarbonate, epoxy resin, polyethylene terephthalate, polyvinyl chloride, polypropylene, silicones, conductive polyaniline, conductive polypyrrole, or combinations thereof.

Examples of the dielectric material that may be useful for detecting humidity may include polyamide, PMMA, PHEMA, cellulose and graphene.

Examples of the dielectric material that may be useful for detecting gases may include cellulose, zeolite, ZnO, TiO₂, and SnO₂. For example, TiO₂ may be used for detecting oxidative gases such as oxygen (O₂), nitrogen dioxide (NO₂), or sulfur dioxide (SO₂), or reductive gases such as hydrogen (H₂), carbon monoxide (CO), ammonia (NH₃), hydrogen sulfide (H₂S), or volatile organic compounds (VOCs). In some embodiments, the microcapsuled described herein include reduced graphene oxide, negative graphene oxide, platinum (Pt) and Pt—Ir (iridium (Ir) doping Pt), or tannin doped polyaniline, which may detect ammonia.

In some embodiments, the change in capacitance of the humidity or gas indicating RFID microchip is irreversible. That is, after the humidity or gas indicating RFID microchip was exposed to a threshold humidity or gas level (e.g., 75% relative humidity (RH)), although it returns to an initial humidity or gas level (e.g., from 75% RH to 40% RH), the humidity or gas indicator 400 may retain the changed capacitance value (e.g., measured at 75% RH) or may not return to its initial capacitance value (e.g., measured at 40% RH before the exposure to the high humidity or gas level). In such embodiments, the dielectric material may undergoes a one way or irreversible change in response to the environmental stimulus, e.g., an irreversible chemical reaction with the detected gas, or a conversion from a crystalline to an amorphous structure in response water from high humidity.

A substrate material for any indicator described herein may be a water impermeable material and may include polyester, polypropylene, polyethylene, vinyl, polyimide, Kimdura®, or any combination thereof. Kimdura® comprises coated, bi-axially oriented, multi-layer polypropylene that features chemical and/or moisture resistance. In some examples, the substrate may be made with a paper or polyethylene terephthalate (PET). In other examples, the substrate may be made with any other suitable non-conductive material or any breathable film, such as cloth or plastic (e.g., polyethylene terephthalate (PET), polyvinyl chloride (PVC), polyvinyl acetate (PVAC), etc.). In some examples, the substrate may also be the surface of a package for a product to be monitored, e.g., incorporating the feature directly in a box or other packing container, or a label material, e.g., an adhesive backed label that may be applied to a package or product.

A wicking material for any indicator described herein includes at least one component from a list consisting of woven polyester, nonwoven polyester, polyamide and blended elastane and polyester, carbon fiber, Teslin synthetic paper, polyethylene, polypropylene, polytetrafluoroethylene, and woven nylon.

Some embodiments may employ a humidity sensing RFID chip similar to chips described in U.S. patent application Ser. No. 17/867,031.

In some embodiments, for any indicator described herein, the indicator is an article of manufacture, comprising a plurality of tags/indicators forming a connected web or sheet. In some of such embodiments, the connected web or sheet has a line of weakness along a boundary in between the adjacent environmentally sensitive tags. In some embodiments, the line of weakness is selected from a fold, a score line, or a perforated line.

### Microcapsules

The indicators described herein utilize microcapsules having impermeable shells which are frangible shells encapsulating payloads (e.g., hygroscopic carriers, colorant, inks, dielectric materials). The shells prevent contact of the payloads with humidity or gas. The frangible shells are rupturable, e.g., the frangible shells rupture and release the payload when subjected to an activation stimulus, rendering the payload sensitive to an environmental stimulus.

The microcapsules may be any size, but in one such embodiment, have an outer diameter length between 20-1000 μm. The microcapsules'frangible impermeable shell can have a thickness between 5 to 25 micrometers (μm). The payload ratio, or the ratio of the total weight of the payload within the microcapsule to the entire weight of the microcapsule including the contents contained within the microcapsule, can range from 5 percent to 90 percent. A variety of microcapsule shell materials may be chosen, depending on the application, the mode of rupture, and the nature of the contents of the microcapsule. In general, the microcapsules should resist the passage, whether by flow, diffusion, or migration, of the contents of the microcapsule prior to rupturing.

In some embodiments, the payload in the microcapsule comprises about 5% to about 90% by weight of the microcapsule, and the permeable material and the sealing material together comprise about 10% to about 95% by weight of the microcapsule.

In some embodiments, the impermeable shell of the microcapsules comprises a single frangible shell. This single frangible shell comprises a combination of at least two components, a permeable material, and a sealing material, which are mixed prior to encapsulation of the payload. The sealing material stabilizes the permeable material and/or plugs pores in the permeable material rendering the microcapsule impermeable to humidity or gas when the microcapsule is intact. The permeable material renders the shell porous when the microcapsule is activated, for example the permeable material may be a side chain crystalline material that melts on application of thermal heat as an activating stimulus.

In some embodiments, the impermeable shell of the microcapsules comprises a frangible dual shell. The inner shell comprises a permeable material that surrounds the payload and is in contact with the payload. The sealing material forms an outer shell which form a continuous phase around the inner shell. The sealing material stabilizes the permeable material and/or plugs pores in the permeable material rendering the microcapsule impermeable to humidity or gas when the microcapsule is intact. When the microcapsule is activated, e.g., by applying pressure or heat, the dual shell microcapsules rupture and release the payload.

In some embodiments, the impermeable shell which forms the frangible shell comprises about 80% to about 95% of the permeable material and about 5% to about 20% of the sealing material by weight of the total material used in the shell.

In some embodiments, the permeable material is selected from polyethylene, polypropylene, polyethylene terephthalate, polyvinyl chloride, polystyrene, ethylene vinyl alcohol, nylon, polycarbonate, acrylates, thermoplastic polyurethane, fats, waxes, fatty acids, alcohols, side chain crystalline (SCC) polymers, sugars (lactose, sucrose, trehalose), shellac, polyethylene glycols, polyvinyl (alcohol, pyrrolidone, acetate), polylactide, polylactide-co-glycolide, polyacrylic acids, polyacrylates, resins (hydrocarbon, terpenes), latex, metals, ethylene-vinyl acetate polymer, fatty alcohols, mono-glycerides, di-glycerides, triglycerides, polyanhydrides, polylactic acid, or sugar derivatives (dextrins).

In some embodiments, the sealing material is selected from polydimethylsiloxane, polymethylsilsesquioxane, silicone polymers, gelatin, protein, polyurea formaldehyde, polymelamine formaldehyde, wax material, melamine, cellulose derivatives (e.g., Ethocel®, Methocel®, HPMCP), polysaccharides (alginate, pectin, pullulan, carrageenans), starches, maltodextrins, proteins (gelatin, zein, casein, caseinate, whey proteins, soy proteins, albumin), chitosan, gums (arabic, xanthan, gellan, guar, pectins), clay/kaolin, or poly(1,1,2,2-tetrafluorethylene). In some embodiments, the clay may be a kaolin. In some embodiments, the clay/kaoplon may be one or more of Montmorillonite, Kaolinite, Bentonite, Illite, Halloysite, Laponite, Sepiolite, or Palygorskite (Attapulgite).

In some embodiments, the permeable material may be a side chain crystalline material and the sealing material may be a clay/kaolin. In some embodiments, the inner shell may comprise a porous organic polymer while the outer shell may comprise an inorganic material coated on the surface of the organic microcapsule shell to form a continuous outer shell. The continuous inorganic shell may block the loss of a liquid payload, and may also resist penetration of external moisture or solvent, thus improving the shell and mechanical properties of microcapsules effectively.

In some embodiments, the sealing material may be wholly, or in part, a wax, e.g., an alkane wax, or other acid resistant compound having a relatively high melting point, e.g., fatty acid amide, an ester or Elvax EVA resin. Such microcapsules are activatable by using a suitable temperature which can cause the shell material to melt. For example, the melting point may be in a range of about 50 degrees Celsius (C.) to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. Generally, the shell should have a higher melting point than the maximum temperature the microcapsule is expected to be exposed to in normal use, to prevent it from rupturing or melting prematurely.

In another embodiment, the sealing material may be wholly, or in part, a polymer coating having a high glass transition temperature (T_{g}) e.g. Polysulfone. For example, the glass transition temperature may be in a range of about 50 degrees C. to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. For example, Polysulfone, with a T_{g} of about 190 C. may be used. In additional examples, the microcapsules 100 may include shells comprising one or more of Styrene Maleic Anhydride (SMA), Polyphenylene Ether (PPE), Cellulose Acetate, Cellulose Diacetate, Polyacrylate, Polyamide, Polycarbonate, polyether ether ketone, Polyether Sulfone, PET, PFA, polymethyl methacrylate (PMMA) or Polyimide.

In some embodiments, the sealing material may be wholly, or in part, a low molecular weight polymer gel having a high melting point, e.g., fatty acid amide, an ester or Elvax EVA resin. For example, the melting point may be in a range of about 100 degrees C. to about 300 degrees C., from about 150 degrees C. to about 300 degrees C., from about 200 degrees C. to about 300 degrees C., from about 250 degrees C. to about 300 degrees C. Additionally, in some examples, the polymer gel has a molecular weight in a range from about 1 grams per mole (g/mol) to 100,000 g/mol, from about 3,500 g/mol to 6,000 g/mol and from about 200 g/mol to 2,000 g/mol.

In some embodiments, the sealing material may be wholly, or in part, a gel, gelatin, protein, polyurea formaldehyde, polymelamine formaldehyde, wax material, melamine, or an emulsion. The microcapsules may be available in wet and dry formulations.

The microcapsule is initially in an unruptured form, capable of being configured to transition to a ruptured form through exposure to an activation action, e.g., the application of heat, pressure, and/or a combination of heat and pressure exceeding a predetermined threshold. In the unruptured form, the frangible shell/impermeable shell of the microcapsule maintains separation between the contents of the microcapsule and any external environmental stimuli such as humidity or gas.

The microcapsules may be “ruptured” (e.g., broken, disengaged, dissolved, fractures, rendered permeable by melting) by applying an activation stimulus to the microcapsule. In some examples “applying an activation stimulus” may constitute exposing the microcapsule to an activation action, such as a pressure stress or a thermal stress, or a combination thereof. The activation action may directly or indirectly cause the frangible shell to fracture, melt, break, dissolve, sublime, become porous, or otherwise disengage, allowing the release of the contents of the frangible shell. In some examples, the frangible shells may be ruptured by one or more activation actions. In some such examples, simultaneous activation actions may be applied to rupture the microcapsules. In other such examples, ordered or non-ordered sequential activation actions may be applied to rupture the microcapsules.

The frangible shells may have one or more of various rupture modes (e.g., or weaking modes), to which the activation action or actions correspond. Each activation action may be configured to have a predetermined activation threshold at which the microcapsule is configured to rupture. In some examples, each activation action may be configured to have a predetermined activation threshold at which the frangible shell of the microcapsule is weakened (e.g., but not ruptured) to a predetermined extent, such that the predetermined activation threshold of a second activation action necessary to rupture the microcapsule is lowered (when compared to the predetermined activation threshold of the second activation alone). Said differently, a first activation action may lower an energy requirement of a second activation action in order to activate the microcapsule.

A first rupture mode is rupture or weaking by means of externally applied pressure. In some examples, the microcapsules may be ruptured by a source of external pressure, where the activation action is an exposure to a compressive or shearing force. The frangible shells may be configured such that the predetermined activation threshold corresponds to a compression stress or a shear stress of sufficient magnitude to rupture the frangible shell. In some examples, the predetermined stress threshold is a compressive stress or a shearing stress exceeding about 0.1 pounds per square inch (psi), a compressive stress or a shearing stress exceeding about 0.5 psi, a compressive stress or a shearing stress exceeding about 1 psi, a compressive stress or a shearing stress exceeding about 2 psi, a compressive stress or a shearing stress exceeding about 5 psi, a compressive stress or a shearing stress exceeding about 10 psi, or a compressive stress or a shearing stress exceeding about 15 psi. The activation stress ranges given are purely exemplary and the microcapsules can be formed to respond to other stress ranges.

A second rupture mode is rupture or weakening by means of internally applied pressure. In some such examples, the microcapsules may be ruptured or weakened by a source of internal pressure, where the activation action may trigger an expansion of a material within the payload (e.g., a volatile material, thermally expandable material) which increases the internal pressure of the microcapsule, which ruptures or weakens the frangible shell.

In some such embodiments, the predetermined activation threshold corresponds to a radial stress or a hoop stress (e.g., acting on the frangible shell) of sufficient magnitude to rupture the frangible shell. In some examples, the predetermined activation stress threshold is a radial stress or hoop stress exceeding about 0.1 pounds per square inch (psi), a radial stress or hoop stress exceeding about 0.5 psi, a radial stress exceeding about 1 psi, a radial stress exceeding about 2 psi, a radial stress or hoop stress exceeding about 5 psi, a radial stress or hoop stress exceeding about 10 psi, or a radial stress or hoop stress exceeding about 15 psi. The activation stress ranges given are purely exemplary and the microcapsules can be formed to respond to other stress ranges.

A third rupture mode is rupture or weaking by means of heat exposure. In some examples, the microcapsules may be ruptured or weakened by a source of heat, where the activation action is an exposure to a temperature configured to melt, degrade, decrease the structural integrity of, or otherwise disengage the frangible shell. In some such examples, the predetermined activation threshold may correspond to a temperature exceeding about 35 degrees C., a temperature exceeding about 40 degrees C., a temperature exceeding about 45 degrees C., a temperature exceeding about 50 degrees C., a temperature exceeding about 55 degrees C., a temperature exceeding about 60 degrees C., a temperature exceeding about 65 degrees C., a temperature exceeding about 70 degrees C., a temperature exceeding about 75 degrees C., a temperature exceeding about 80 degrees C., a temperature exceeding about 85 degrees C., a temperature exceeding about 90 degrees C., a temperature exceeding about 95 degrees C., and a temperature exceeding about 100 degrees C. The activation heat ranges given are purely exemplary and the microcapsules can be formed to respond to other temperature ranges.

In some examples in which two activation actions are required to rupture the microcapsules, the activation actions may employ the same rupture modes, enacted at different thresholds, or different rupture modes.

In some examples, the thermal activation may be applied by a thermal printhead (e.g., of a thermal printer). Thermal printheads are generally configured to provide a source of heat (e.g., via heating elements) and a source of external pressure (e.g., via a nib formed between a platen roller and the printhead). Typical thermal print heads have temperatures in the range from about 100° C. to 300° C., which may be tuned downward for select applications to from about 100 ° C. to 200° C. They are typically exposed to thermal print heads for a brief period of time, for example a few milliseconds. Furthermore, the platen roller may be configured, adjusted, or tuned, such that the external pressure applied by the thermal printhead (e.g., and the platen roller) is in the range of 0.1 psi to 15 psi. As a non-limiting example, the microcapsules may be configured such that the heat from the thermal printhead triggers a thermally expansive material contained in the microcapsule to expand, providing an internal pressure source, which weakens the frangible shell, and the external compressive force of the nib provides sufficient stress to rupture the frangible shell, rupturing the microcapsules.

The activation pressure and temperature ranges given are purely exemplary and other ranges may be sufficient to rupture or weaken the frangible shells, where such pressure ranges may vary based on a composition of the frangible shell, a thickness of the frangible shell, a ratio between the shell thickness or weight to volume or weight of the indicator material, a diameter of the microcapsules, a temperature applied to the shells, etc.

According to some embodiments, the frangible shell is electrically nonconductive, insulative, resistive, or otherwise resists, and may substantially prevent the conduction of electricity through the microcapsule.

### Methods of Making Microcapsules

In some embodiments, the microcapsules described herein are prepared by interfacial polymerization of two polymers (e.g., polymelamine and polyurea formaldehyde), which uses two immiscible phases. Once separated in the same vessel, a reaction is initiated at the interface of the two immiscible phases in the presence of an initiator and the material to be encapsulated. As polymerization occurs, microcapsules form around the core material. The microcapsule releases the contents of the microcapsule upon rupturing.

In some embodiments, the microcaspules described herein are prepared by coacervation. Two oppositely charged polymers are used to create a shell around a payload. A payload to be encapsulated is dispersed in water in a stirred tank. Solutions of the two polymers are added to the stirred tank. The pH of the mixture in the tank is changed (e.g., acid is added to change the pH of the mixture in the tank), causing the two polymers to bind. Coacervation may be used for encapsulating both hydrophilic and hydrophobic payloads. The release of encapsulated payloads may be achieved by an activation stimulus such as changing the pH, ionic strength, or temperature.

In some embodiments, the microcapsules described herein are prepared by a coaxial extrusion via a three-fluid coextrusion process. A set of concentric coaxial nozzles is used to simultaneously extrude three immiscible fluids, forming a core-shell structure such that an impermeable shell surrounds a payload. The innermost fluid forms the core, i.e., a payload described herein, the middle fluid is a permeable material which forms a first shell that is in contact with the payload, and the outermost fluid is a sealing material which acts as a continuous phase or an additional shell that plugs the pores in the permeable material's shell. As these fluids exit the nozzle, they form a continuous stream that breaks into droplets. The surrounding continuous phase/second shell stabilizes the droplets, preventing them from coalescing. The droplets then solidify into microspheres through mechanisms such as cooling, solvent evaporation, or chemical reactions such as UV crosslinking. In some embodiments, coaxial extrusion may include inline crosslinking. The resulting microspheres are collected, washed, and processed to ensure stability and remove any residual solvents.

In some embodiments, the microcapsules described herein are prepared by a coaxial extrusion via a two-fluid coextrusion process. A set of concentric coaxial nozzles is used to simultaneously extrude 2 immiscible fluids, forming a core-shell structure such that an impermeable shell surrounds a payload. The innermost fluid forms the core, i.e., a payload described herein. The outer fluid is a mixture of a permeable material and a sealing material which forms a shell that is in contact with the payload. The sealing material forms a continuous phase that can plug the pores in the permeable material. As these fluids exit the nozzle, they form a continuous stream that breaks into droplets. The droplets then solidify into microspheres through mechanisms such as cooling, solvent evaporation, or chemical reactions such as UV crosslinking. In some embodiments, coaxial extrusion may include inline crosslinking. The resulting microspheres are collected, washed, and processed to ensure stability and remove any residual solvents. A mixture of the microspheres in a suitable solvent is then overlaid in an indicator area of a substrate.

In a spinning disk method, a rotating disk is used, onto which a liquid feed containing the material to be encapsulated (i.e., the payload) is introduced. As the disk spins, centrifugal forces drive the liquid outward, causing the liquid film to break into droplets. The size of these droplets is influenced by factors such as the rotational speed of the disk, the viscosity of the liquid, and surface tension. The droplets solidify into microspheres as they travel through the air or a collection medium, undergoing processes like cooling or solvent evaporation. These microspheres are collected in a surrounding medium or chamber, where further processing may occur to dry and purify them. In some embodiments, the microspheres may be coated with one of more shells as described herein. This method may provide the ability to produce uniform microspheres in large quantities.

A mixture of the microspheres in a suitable solvent is then overlaid in an indicator area of a substrate. In some embodiments, the mixture is roller coated or flexo printed on an area of the substrate. The mixture may further comprise a binder, a viscosity modifier, a surfactant and/or a carrier. The microsphere coating may be dried e.g., by forced air dry oven exposure.

In some examples, the humidity or gas indicators 200, 300 and/or 400 may be used for a product/container having a host product that may be sensitive to the change in humidity or gas concentration or that may generate gas when the host product is in an abnormal condition. The humidity or gas indicators 200, 300 and/or 400 may be associated with the host product and/or the container to monitor a humidity or gas level change of the host product/container. For example, the humidity or gas indicators 200, 300 and/or 400 may be attached to the host product and/or the container, or at a place near the host product and/or the container. Examples of host products may include food stuffs, flowers, concrete, batteries, vaccines, drugs, medication, pharmaceuticals, cosmeceuticals, nutricosmetics, nutritional supplements, biological materials for industrial or therapeutic uses, medical devices, electrical devices, prophylactics, cosmetics, beauty aids, and perishable munitions and ordnance. In some examples, the capacitance of the humidity or gas indicators 400 may be read using a capacitance meter or multimeter (e.g., BK 878B).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any manner. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain manner is configured in at least that manner, but may also be configured in manners that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A humidity-or gas-exposure indicator, comprising:
a substrate;
a plurality of humidity or gas-impermeable microcapsules on or in the substrate, the microcapsules comprising a humidity-or gas-sensitive payload, the microcapsules preventing exposure of the payload to humidity or gas while intact, the payload producing an observable effect indicating the presence of humidity or gas when exposed to humidity or gas above a predetermined threshold after the microcapsules have been exposed to an activating stimulus which ruptures, fractures, dissolves, or renders permeable the microcapsules.

2. The indicator of claim 1, wherein the observable effect is a change in a color state of the indicator, wherein the change in color state comprises a change of at least one property selected from hue, chroma, transparency, opacity, or combinations thereof.

3. The indicator of claim 1, wherein the payload is a hydrochromic ink.

4. The indicator of claim 3, wherein the hydrochromic ink is selected from a mixture of a triphenylmethane dye, an oxidizing agent, a base and a humectant; a mixture of an inorganic weak acid, a triarylmethane dye, and a hygroscopic agent; a mixture of copper bromide, a dye and a bromide salt; a silica gel impregnated iron (III) salt; a sugar gel containing ionic dyes; a composite of porphyrin, magnesium dichloride and silica gel; an inorganic polymer containing an acid-base indicator; hydroxyethyl cellulose containing methylene blue and urea; a composite of polyvinyl alcohol and sodium borate decahydrate; lithium hydroxide; calcium hydroxide; potassium hydroxide; sodium hydrogen carbonate; magnesium hydroxide; sodium thiosulfate pentahydrate; sodium hydroxide; cobalt nitrate; copper (II) sulfate; copper nitrate; iron (III) sulfate; iron (II) sulfate; iron (II) Chloride; iron (III) chloride; Cobalt (II) Chloride; or magnesium chloride; or any combination thereof.

5. The indicator of claim 3, wherein the microcapsules are transparent or translucent while intact.

6. The indicator of claim 1, further comprising an indicator area, wherein after the activation stimulus is applied to the microcapsules, and responsive to the payload being exposed to a predetermined level of humidity or gas, at least a portion of the payload migrates to the indicator area, the presence of the payload in the indicator area producing the observable effect.

7. The indicator of claim 1, wherein the indicator further comprises an electrical circuit, and wherein the payload, when released from the microcapsules and exposed to gas or humidity produces a change of electrical property in a component of the electrical circuit.

8. (canceled)

9. The indicator of claim 1, wherein the indicator is a humidity indicator, the payload includes a hygroscopic carrier, and exposure to humidity above a predetermined level causes the hygroscopic carrier to liquify, the liquified hygroscopic carrier flowing to the indicator area.

10. (canceled)

11. (canceled)

12. The indicator of claim 9, wherein the payload further includes a material selected from the group consisting of PVA, PVP, PEG, acrylics, water reducible epoxy, cellulose, water soluble gum, PEG, titanium dioxide nanoparticles, barium titanate nanoparticles, silicon dioxide nanoparticles, carbon black, graphene, metallic nanoparticles, PVDF, polystyrene, polyethylene, ionic liquids, lead zirconate titanate, aluminum oxide, zinc oxide, magnesium oxide, iron oxide, manganese dioxide, copper oxide, nickel oxide, strontium titanate, zirconium dioxide, calcium copper titanate, boron nitride, cadmium sulfide, lead magnesium niobate, lanthanum nickelate, hafnium oxide, yttrium oxide, indium tin oxide, gallium nitride, tantalum pentoxide, bismuth ferrite, polytetrafluoroethylene, polyimide, polycarbonate, epoxy resin, polyethylene terephthalate, polyvinyl chloride, polypropylene, silicones, conductive polyaniline, conductive polypyrrole, or combinations thereof.

13. The indicator of claim 9, wherein the hygroscopic carrier that liquifies in the presence of humidity is a polymer, a metal salt, or a metal oxide.

14. (canceled)

15. (canceled)

16. A microcapsule comprising
a humidity- or gas-sensitive payload core;
a humidity- or gas-impermeable shell surrounding the payload core and including a permeable material for forming a shell surrounding, and in contact with, the payload, and a sealing material;
where the shell, after exposure to an activating stimulus, ruptures, fractures, dissolves, or renders permeable the microcapsule.

17. The microcapsule of claim 16, wherein the sealing material seals pores in the permeable material.

18. The microcapsule of claim 16, wherein the permeable material is selected from polyethylene, polypropylene, polyethylene terephthalate, polyvinyl chloride, polystyrene, ethylene vinyl alcohol, nylon, polycarbonate, acrylates, thermoplastic polyurethane, fats, waxes, fatty acids, alcohols, side chain crystalline (SCC) polymers, sugars (lactose, sucrose, trehalose), shellac, polyethylene glycols, polyvinyl (alcohol, pyrrolidone, acetate), polylactide, polylactide-co-glycolide, polyacrylic acids, polyacrylates, resins (hydrocarbon, terpenes), latex, metals, ethylene-vinyl acetate polymer, fatty alcohols, mono-glycerides, di-glycerides, triglycerides, polyanhydrides, polylactic acid, or sugar derivatives (dextrins).

19. The microcapsule of claim 16, wherein the sealing material is selected from polydimethylsiloxane, polymethylsilsesquioxane, silicone polymers, gelatin, protein, polyurea formaldehyde, polymelamine formaldehyde, wax material, melamine, Cellulose derivatives (Ethocel, Methocel, HPMCP), polysaccharides (alginate, pectin, pullulan, carrageenans), starches, maltodextrins, proteins (gelatin, zein, casein, caseinate, whey proteins, soy proteins, albumin), chitosan, gums (arabic, xanthan, gellan, guar, pectins), clay/kaolin, or poly(1,1,2,2-tetrafluorethylene).

20. The microcapsule of claim 16, wherein the payload comprises about 5% to about 90% by weight of the microcapsule, and the permeable material and the sealing material together comprise about 10% to about 95% by weight of the microcapsule.

21. The microcapsule of claim 16, wherein the shell comprises about 80% to about 95% of the permeable material and about 5% to about 20% of the sealing material by weight of the total material used in the shell.

22. The microcapsule of claim 16, wherein the permeable material is an SCC polymer and the sealing material is a clay/kaolin.

23. A process, comprising:
providing a humidity-or gas-sensitive payload;
providing a permeable material for forming a shell surrounding, and in contact with, the payload;
providing a sealing material; and
co-extruding the payload, the permeable material, and the sealing material to provide a microcapsule having a humidity- or gas-sensitive payload core surrounded by a humidity- or gas-impermeable shell when intact, and which, after exposure to an activating stimulus, ruptures, fractures, dissolves, or renders permeable the microcapsules.

24-28. (canceled)

29. The process of claim 23, further comprising:
providing a substrate; and
overlaying the substrate with the microcapsules.

30. The indicator of claim 1, wherein the activating stimulus is at least one of (a) pressure, preferably a pressure in the range of 5 psi to 20 psi, or (b) heating above a threshold temperature, the threshold temperature preferably in a range of 25° C. to 250° C.
